(19) United States
(12) Patent Application Publication
(10) Pub. No.: US 2010/0033000 A1
(43) Pub. Date: Feb. 11, 2010

(54) Vehicle Attachable Child Booster Type Car Seat With Lap Belt

(76) Inventor: Sanjeev Kumar Singh, Danbury, CT (US)

Correspondence Address: Sanjeev Kumar Singh, 54 Lawerence Ave, Danbury, CT, 06810, US

(21) Appl. No.: 12/507,457

(22) Filed: Jul. 22, 2009

Related U.S. Application Data
(60) Provisional application No. 61/086,413, filed on Aug. 5, 2008.

(51) Int. Cl. B60N 2/28

(52) U.S. Cl. 297/250.1

(57) ABSTRACT

A vehicle attachable child booster type car seat is provided with a lap belt for in situ restraining the car seat at a vehicle seat by using a vehicle safety seat belt having a first vehicle seat belt buckle and a first vehicle seat belt prong. In one embodiment of the present invention, a booster seat is configured to have a second vehicle seat belt buckle and a second vehicle seat belt prong to mate with the first vehicle seat belt prong and the first vehicle seat belt buckle, respectively, when positioned on the vehicle seat of a motor vehicle. Therefore, instead of the booster seat being merely an unattached cushion boosting a child occupant's position, may rather be anchored at the vehicle seat while the vehicle safety seat belt's functionality still retained along with an additional restraining capability of the lap belt that can secure a torso portion of the child occupant seated in the booster seat. Such anchoring of a body of the booster seat to a vehicle seat belt system near a seating base of the vehicle seat may avoid dislodging of a seat pan of the booster seat from the top of the vehicle seat in response to an impact force or sudden breaking of the motor vehicle.

### CROSS REFERENCE TO RELATED APPLICATIONS

This application claims priority under 35 U.S.C. 119(e) to U.S. provisional application Ser. No. 61/086,413, filed Aug. 5, 2008, which is expressly incorporated by reference herein in its entirety into this application.

### BACKGROUND OF THE INVENTION

1. Field of the Invention

This invention relates generally to child booster type car seats and more particularly, to child booster type car seats with a lap belt that are capable of attaching to a vehicle seat belt system while filly retaining a seat belt functionality.

2. Description of the Related Art

National Highway Traffic Safety Administration (NHTSA) recommends that rear-facing seats be used in the back seat from birth to at least 1 year old and at least 20 pounds. Forward-facing toddler seats to be used in the back seat from age 1 and 20 pounds to about age 4 and 40 pounds. Booster seats to be used in back seat from about age 4 to until they are at least 8 years old, unless they are 4′9″ tall. Safety seat belts to be used at age 8 and older or taller than 4′9″. All children age 12 and under should ride in the back seat of a vehicle.

Booster seats are used because safety seat belts in vehicles are not designed for children. Beginning at about 4 years old age, many children outgrow toddler seats but still they are too small for adult-sized safety seat belts. A booster seat raises the child up so that a safety seat belt properly fits—and can better protect the child. A three point safety belt of most modern vehicles includes a shoulder and a lap belt. The shoulder belt should cross the child's chest and rest snugly on the shoulder, and the lap belt should rest low across the pelvis or hip area. Most 4 to 8 years old children need booster seats. National Highway Traffic Safety Administration (NHTSA) recommends that children who have outgrown child safety seats should be properly restrained in booster seats until they are at least 8 years old, unless they are 4′9″ tall.

Generally there are two types of booster seats. The first type is called high-back belt-positioning booster seats and the second type is called no-back belt-positioning booster seat. Two types of high-back belt-positioning booster seats are available. Both types “boost” the child up so the vehicle safety seat belt fits better. One type provides head and neck support for the child if a vehicle seat back does not have a head rest. It must be used with the vehicle's lap/shoulder belt, never with the lap belt only. The other, a combination seat, converts from a forward-facing toddler seat to a booster seat and comes equipped with a harness. This type can be used as a forward-facing toddler seat when the child is age 1 and at least 20 pounds to about age 4 and 40 pounds. When the child outgrows the toddler seat, remove the harness and use the seat as a booster seat with the vehicle's lap/shoulder belt. The no-back belt-positioning booster seat type also “boosts” the child up so the vehicle safety seat belt fits better. This booster seat is used with a lap/shoulder belt. It should only be used in vehicles with built-in head rests. All booster seats are required by law to comply with the same safety standards as child safety seats. A booster seat must have a label stating that it meets Federal motor vehicle safety standards.

According to an article published in the New York Times on Jul. 10, 2005, a given car seat is a combination of straps, tethers and harnesses designed by anyone of bunch of manufacturers whose products must be secured by the diverse seat-belt configurations of any passenger vehicle sold in the United States. According to the NHTSA, however, more than 80 percent of car seats are improperly installed. But NHTSA data appear to show that car seats are indeed a remarkable lifesaver. Although motor-vehicle crashes are still the top killer among children from 2 to 14, fatality rates have fallen steadily in recent decades—a drop that coincides with the rise of car-seat use. One compelling statistic about car seats by NHTSA is: “They are 54 percent effective in reducing deaths for children ages 1 to 4 in passenger cars.” This is 54 percent effective compared with a child's riding completely unrestrained even though there is another mode of restraint: safety seat belts.

For children younger than roughly 24 months, safety seat belts plainly won't do. For them, a car seat represents the best practical way to ride securely. But for older children would safety seat belts afford them the same protection as car seats?

Fatality Analysis Reporting System (FARS) compiles police reports on all fatal crashes in the U.S. since 1975. There data includes different variables in a crash, including whether the occupants were restrained and how. The FARS data reveals that among children 2 and older, the death rate is no lower for those traveling in any kind of car seat than for those wearing safety seat belts. According to the FARS data, there is no evidence that car seats do a better job than seat belts in saving the lives of children older than 2. In certain kinds of crashes—rear-enders, for instance—car seats actually perform worse. The answer to why child auto fatalities have been falling seems to be that more and more children are restrained in some way. Many of them happen to be restrained in car seats, since that is what the government mandates, but if the government instead mandated proper safety seat belt use for children, they would likely do just as well, without much expense, regulation and anxiety associated with car seats.

NHTSA recommends that all older children (usually starting at about age 4) ride in booster seats, which boost a child to a height where the adult lap-and-shoulder belts fit properly. In 2001, the Insurance Institute for Highway Safety sent NHTSA a memo warning that its booster-seat recommendations were “getting ahead of science and regulations” and that certain booster seats “did not improve belt fit, and some actually worsened the fit.” If booster seats are shown in the FARS data to be no more effective than safety seat belts, might it be because so many of them are improperly installed?

Most child-safety experts advocate that neck or abdominal injuries are worse with use of safety seat belts alone. That is, one 4-year-old in a lap-and-shoulder belt may find the shoulder belt so irritating that he puts it behind his back and another 4-year-old may be in a poorly installed booster seat.

Parents in America spend many hundred million dollars each year on car seats including booster type car seats that may not add much lifesaving value. That is, the current booster seats may not be the safety miracle device that most parents have been taught to believe. But children should always ride with some kind of restraint—and a booster seat may be the only legal option.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a booster seat is provided for use in a vehicle with a vehicle safety seat belt having a first vehicle seat belt buckle and a first vehicle seat belt prong. The booster seat comprises a seat body having first and second distal ends for seating a child occupant thereon. The booster seat further comprises a second vehicle seat belt buckle coupled to the seat body for mating with the first vehicle seat belt prong to restrain the booster seat at a vehicle seat. The booster seat further comprises a second vehicle seat belt prong coupled to the seat body for mating with the first vehicle seat belt buckle coupled to the vehicle seat such that the booster seat attachable in situ to the vehicle seat at the first distal end.

In another embodiment of the present invention, a child car seat comprises a seating portion to boost a child occupant up so a shoulder belt and a lap belt of a vehicle safety seat belt fit the child occupant when restrained therewith. The vehicle safety seat belt having a first vehicle seat belt buckle and a first vehicle seat belt prong. The child car seat further comprises a back rest portion coupled to the seating portion. A second vehicle seat belt buckle and a second vehicle seat belt prong coupled to the child car seat for coupling to the vehicle safety seat belt.

In yet other embodiment of the present invention, a method is provided for enabling restraining of a booster seat in a vehicle with a vehicle safety seat belt having a first vehicle seat belt buckle and a first vehicle seat belt prong. The method comprises providing the booster seat comprising a body including a seat back and a seat pan for seating a child occupant thereon. The method further comprises enabling coupling a second vehicle seat belt buckle to the body for mating with the first vehicle seat belt prong to restrain the booster seat at a vehicle seat. The method further comprising enabling coupling a second vehicle seat belt prong to the body for mating with the first vehicle seat belt buckle coupled to the vehicle seat such that the booster seat in situ attachable to the vehicle seat.

### BRIEF DESCRIPTION OF THE DRAWINGS

The invention may be understood by reference to the following description taken in conjunction with the accompanying drawings, in which like reference numerals identify like elements, and in which:

FIG. 1 schematically illustrates a booster seat in accordance with one embodiment of the present invention; and

FIG. 2 schematically illustrates a child car seat in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a vehicle attachable child booster type car seat is provided with a lap belt for in situ restraining the car seat at a vehicle seat by using a vehicle safety seat belt having a first vehicle seat belt buckle and a first vehicle seat belt prong. In one embodiment of the present invention, a booster seat is configured to have a second vehicle seat belt buckle and a second vehicle seat belt prong to mate with the first vehicle seat belt prong and the first vehicle seat belt buckle, respectively, when positioned on the vehicle seat of a motor vehicle. Therefore, instead of the booster seat being merely an unattached cushion boosting a child occupant's position, may rather be anchored at the vehicle seat while the vehicle safety seat belt's functionality still retained along with an additional restraining capability of the lap belt that can secure a torso portion of the child occupant seated in the booster seat. Such anchoring of a body of the booster seat to a vehicle seat belt system near a seating base of the vehicle seat may avoid dislodging of a seat pan of the booster seat from the top of the vehicle seat in response to an impact force or sudden breaking of the motor vehicle.

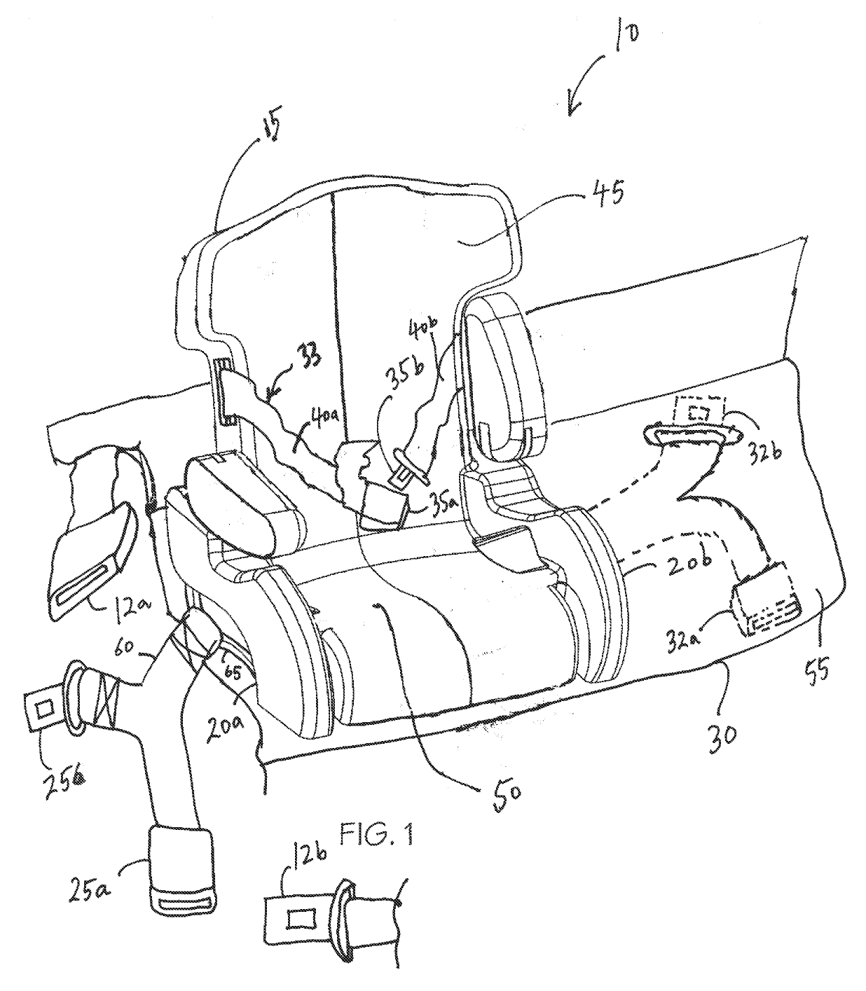

Referring to FIG. 1, a booster seat 10 for use in a vehicle with a vehicle safety seat belt is provided according to one embodiment of the present invention. The vehicle safety seat belt includes a first vehicle seat belt buckle 12a and a first vehicle seat belt prong, 12b. The booster seat 10 comprises a seat body 15 having first and second distal ends 20a, 20b respectively, for seating a child occupant thereon. The seat body 15 of the booster seat 10 further comprises a second vehicle seat belt buckle 25a coupled to the seat body for mating with the first vehicle seat belt prong 12a to restrain the booster seat 10 at a vehicle seat 30. The seat body 15 of the booster seat 10 further comprises a second vehicle seat belt prong 25b. The second vehicle seat belt prong 25b may be coupled to the seat body 15 for mating with the first vehicle seat belt buckle 12a coupled to the vehicle seat 30 such that the booster seat 10 is attachable in situ to the vehicle seat 30 at the first distal end 20a.

The booster seat 10, as shown in FIG. 1, further comprises a seat belt buckle 32a coupled to the seat body 15 at the second distal end 20b. A seat belt prong 32b may be coupled to the seat body 15 at the second distal end 20b for mating with the seat belt buckle 32a such that the booster seat 10 attachable in situ to a seat belt webbing of the vehicle safety seat belt.

Examples of the booster seat 10 include a child booster seat such as having a body similar to one available in the market. One example of the booster seat 10 is shown in U.S. Pat. No. 6,682,143, which is incorporated herein in its full entirety.

The booster seat 10, as shown in FIG. 1 further comprises a lap belt 33 coupled to the seat body 15. The lap belt 33 includes a seat belt webbing length adjusting buckle 35a coupled to a first harness length 40a. The lap belt 33 further includes a prong 35b coupled to a second harness length 40b. The seat belt webbing length adjusting buckle 35a is capable of mating with the prong 35b. Each harness length being located on opposed sides of the seat body 15 along the height of the seat body to secure a torso portion of the child occupant.

Examples of the lap belt 33 include an airplane seat belt. One example of the lap belt 33 can be found in U.S. Pat. No. 5,088,160, which is hereby incorporated in this patent application in its entirety.

In one embodiment of the present invention, the lap belt 33 may have a jacket structure suitable for a booster seat age child. For example, the lap belt 33 may comprise a jacket to cover a chest portion of the child occupant.

In operation, the booster seat's 10, the second vehicle seat belt buckle 25a and the second vehicle seat belt prong 25b enable the vehicle safety seat belt to guide over the child occupant located in the booster seat 10 and couple to the vehicle safety seat belt consistent with one embodiment of the present invention.

According to one embodiment of the present invention, the seat body 15 includes a seat back 45 and a seat pan 50 for seating a child such that the booster seat 10 is in situ attachable to the vehicle safety seat belt at the vehicle seat while being disposed on a top of the vehicle seat 30.

In operation, coupling of the seat body 15 of the booster seat 10 to a vehicle seat belt system at the vehicle seat 30 may avoid dislodging of the seat pan 50 from the top of the vehicle seat 30 in response to an impact force or sudden breaking of the vehicle.

In one embodiment, the present invention, the booster seat's 10, the second vehicle seat belt buckle 25a and the second vehicle seat belt prong 25b being permanently and non-removably affixed to the seat pan 50 for in situ attachment to an anchor point associated with a bottom seating base 55 of the vehicle seat 30.

In one embodiment, the booster seat 10 comprises a leash 60 coupled to the seat body 15 and having a distal end, wherein the second vehicle seat belt buckle 25a and the second vehicle seat belt prong 25b is being coupled to the distal end of the leash 60. The leash 60 may comprise a webbing length 65 being anchored to the seat body 15 about a middle point of a body width such that the second vehicle seat belt buckle 25a and the second vehicle seat belt prong 25b coupled to the distal end reach on either side end of the body width.

In one embodiment, the booster seat 10 may further comprise a third vehicle seat belt prong such as the prong 32b coupled to the seat body 15 for mating with a fourth vehicle seat belt buckle associated with a second vehicle seat of the vehicle. The booster seat 10 may further comprise a third vehicle seat belt buckle such as the buckle 32a coupled to the seat body for mating with a fourth vehicle seat belt prong associated with the second vehicle seat of the vehicle. The second vehicle seat belt buckle 25a with the second vehicle seat belt prong 25b and the third vehicle seat belt buckle 32a with the third vehicle seat belt prong 32b anchored at opposite sides of the seat body 15.

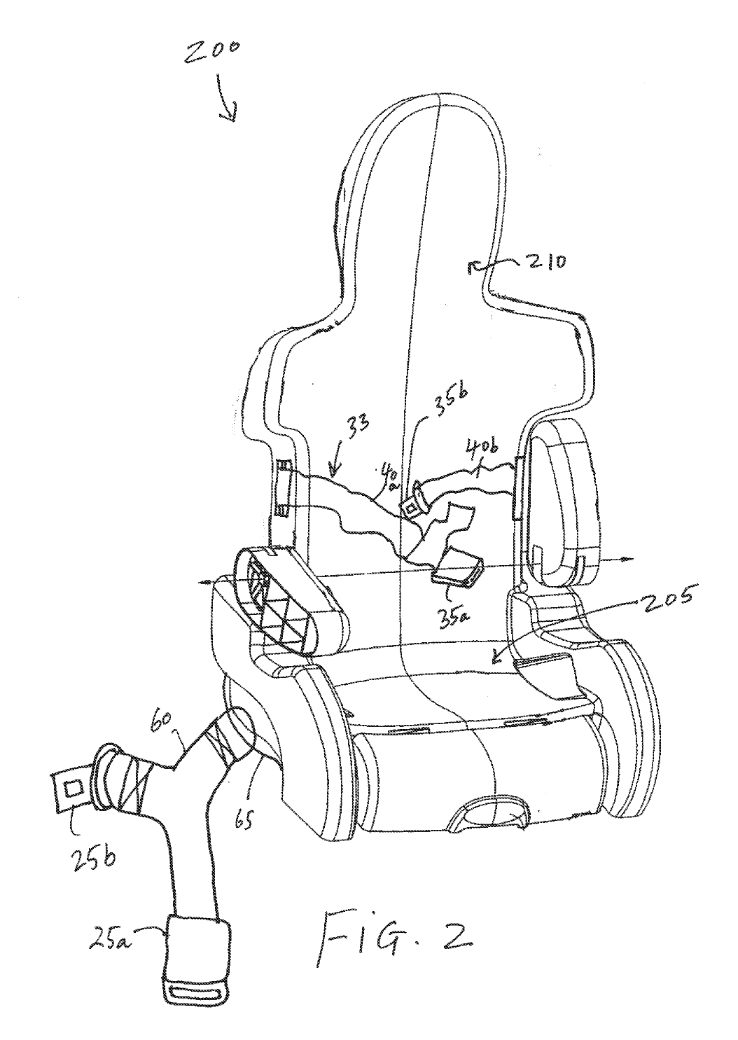

Referring to FIG. 2, a child car seat 200 is schematically shown according to one embodiment of the present invention. The child car seat 200 is configured to engage with a vehicle seat belt system when located over the vehicle seat in a forward facing position. The child car seat 200 may comprise a seating portion 205 to boost a child occupant up so a shoulder belt and a lap belt of a vehicle safety seat belt fit the child occupant when restrained therewith. The vehicle safety seat belt includes the first vehicle seat belt buckle 12a and the first vehicle seat belt prong 12b, as shown in FIG. 1. The child car seat 200 may further comprise a back rest portion 210 coupled to the seating portion. In one embodiment, the second vehicle seat belt buckle 25a and the second vehicle seat belt prong 25b are coupled to the child car seat 200 for coupling to the vehicle safety seat belt.

Consistent with one embodiment of the present invention, the second vehicle seat belt buckle 25a to mate with the first vehicle seat belt prong 12b and the second vehicle seat belt prong 25b to mate with the first vehicle seat belt buckle 12a such that the child car seat 200 in situ attachable to the vehicle safety seat belt of a motor vehicle when positioned on a motor vehicle seat.

The child car seat 200, as set forth herein in accordance with one embodiment, may be configured to couple the vehicle safety seat belt for restraining the child occupant of age about 4 and 40 pounds to at least 8 years old, unless 4′9″ tall in a forward-facing position.

According to one embodiment of the present invention, a method is provided for enabling restraining of the booster seat 10 in a vehicle with a vehicle safety seat belt having the first vehicle seat belt buckle 12a and the first vehicle seat belt prong 12b. The method further comprises providing the booster seat 10 comprising the body 15 including the seat back 45 and the seat pan 50 for seating a child occupant thereon.

The method further comprises enabling coupling the second vehicle seat belt buckle 25a to the body 15 for mating with the first vehicle seat belt prong 12b to restrain the booster seat 10 at the vehicle seat 30. The method further comprises enabling coupling the second vehicle seat belt prong 25b to the body 15 for mating with the first vehicle seat belt buckle 12a coupled to the vehicle seat 30 such that the booster seat 10 in situ attachable to the vehicle seat 30. The method further comprises providing the lap belt 33 coupled to the body 15. The lap belt 33 having a seat belt webbing length adjusting buckle coupled to a first harness length and a prong coupled to a second harness length. The seat belt webbing length adjusting buckle is capable of mating with the prong.

Examples of a basic booster seat structure for making the booster seat 10 and a basic child car seat structure for making the child car seat 200 can be found in U.S. Pat. No. 6,682,143, which is hereby incorporated in this patent application in its entirety.

Portions of the present invention and corresponding detailed description are presented in terms of physical and symbolic representations of components. These descriptions and representations are the ones by which those of ordinary skill in the art effectively convey the substance of their work to others of ordinary skill in the art. It should be borne in mind, however, that all of these and similar components are to be associated with the appropriate physical quantities and are merely convenient labels applied to these structures.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A booster seat for use in a vehicle with a vehicle safety seat belt having a first vehicle seat belt buckle and a first vehicle seat belt prong, the booster seat comprising:
a seat body having first and second distal ends for seating a child occupant thereon;
a second vehicle seat belt buckle coupled to the seat body for mating with the first vehicle seat belt prong to restrain the booster seat at a vehicle seat; and
a second vehicle seat belt prong coupled to the seat body for mating with the first vehicle seat belt buckle coupled to the vehicle seat such that the booster seat attachable in situ to the vehicle seat at the first distal end.

2. The booster seat, as set forth in claim 1, further comprising:
a seat belt buckle coupled to the seat body at the second distal end; and
a seat belt prong coupled to the seat body at the second distal end for mating with the seat belt buckle such that the booster seat attachable in situ to a seat belt webbing of the vehicle safety seat belt.

3. The booster seat, as set forth in claim 1, further comprising:
a lap belt coupled to the seat body, the lap belt including:
a seat belt webbing length adjusting buckle coupled to a first harness length; and
a prong coupled to a second harness length, wherein the seat belt webbing length adjusting buckle is capable of mating with the prong, wherein each harness length being located on opposed sides of the seat body along the height of the seat body to secure a torso portion of the child occupant.

4. The booster seat, as set forth in claim 2, wherein the lap belt is an airplane seat belt.

5. The booster seat, as set forth in claim 2, wherein the lap belt comprises a jacket to cover a chest portion of the child occupant.

6. The booster seat, as set forth in claim 1, wherein the second vehicle seat belt buckle and the second vehicle seat belt prong enable the vehicle safety seat belt to guide over the child occupant located in the booster seat and couple to the vehicle safety seat belt.

7. The booster seat, as set forth in claim 1, wherein the seat body including a seat back and a seat pan for seating a child such that the booster seat in situ attachable to the vehicle safety seat belt at the vehicle seat while being disposed on a top of the vehicle seat.

8. The booster seat, as set forth in claim 7, wherein coupling of the seat body of the booster seat to the vehicle seat belt system at the vehicle seat to avoid dislodging of the seat pan from the top of the vehicle seat in response to an impact force or sudden breaking of the vehicle.

9. The booster seat, as set forth in claim 7, wherein the second vehicle seat belt buckle and the second vehicle seat belt prong being permanently and non-removably affixed to the seat pan for in situ attachment to an anchor point associated with a bottom seating base of the vehicle seat.

10. The booster seat, as set forth in claim 1, further comprising:
a leash coupled to the seat body and having a distal end, wherein the second vehicle seat belt buckle and the second vehicle seat belt prong coupled to the distal end of the leash.

11. The booster seat, as set forth in claim 10, wherein the leash comprising:
a webbing length being anchored to the seat body about a middle point of a body width such that the second vehicle seat belt buckle and the second vehicle seat belt prong coupled to the distal end reach on either side end of the body width.

12. The booster seat, as set forth in claim 1, further comprising:
a third vehicle seat belt prong coupled to the seat body for mating with a fourth vehicle seat belt buckle associated with a second vehicle seat of the vehicle.

13. The booster seat, as set forth in claim 12, further comprising:
a third vehicle seat belt buckle coupled to the seat body for mating with a fourth vehicle seat belt prong associated with the second vehicle seat of the vehicle.

14. The booster seat, as set forth in claim 12, wherein the second vehicle seat belt buckle with the second vehicle seat belt prong and the third vehicle seat belt buckle with the third vehicle seat belt prong anchored at opposite sides of the seat body.

15. The booster seat, as set forth in claim 1, wherein the booster seat is a child car seat which is configured to engage with a vehicle seat belt system when located over the vehicle seat in a forward facing position.

16. A child car seat, comprising:
a seating portion to boost a child occupant up so a shoulder belt and a lap belt of a vehicle safety seat belt fit the child occupant when restrained therewith, wherein the vehicle safety seat belt having a first vehicle seat belt buckle and a first vehicle seat belt prong; and
a back rest portion coupled to the seating portion, wherein a second vehicle seat belt buckle and a second vehicle seat belt prong coupled to the child car seat for coupling to the vehicle safety seat belt.

17. The child car seat, as set forth in claim 16, wherein the second vehicle seat belt buckle to mate with the first vehicle seat belt prong and the second vehicle seat belt prong to mate with the first vehicle seat belt buckle such that the child car seat in situ attachable to the vehicle safety seat belt of a motor vehicle when positioned on a motor vehicle seat.

18. The child car seat, as set forth in claim 16, wherein the child car seat configured to the vehicle safety seat belt for restraining the child occupant of age about 4 and 40 pounds to at least 8 years old, unless 4′9″ tall in a forward-facing position.

19. A method for enabling restraining of a booster seat in a vehicle with a vehicle safety seat belt having a first vehicle seat belt buckle and a first vehicle seat belt prong, the method comprising:
providing the booster seat comprising a body including a seat back and a seat pan for seating a child occupant thereon;
enabling coupling a second vehicle seat belt buckle to the body for mating with the first vehicle seat belt prong to restrain the booster seat at a vehicle seat; and
enabling coupling a second vehicle seat belt prong to the body for mating with the first vehicle seat belt buckle coupled to the vehicle seat such that the booster seat in situ attachable to the vehicle seat.

20. The method, as set forth in claim 19, further comprising:
providing a lap belt coupled to the body, the lap belt having a seat belt webbing length adjusting buckle coupled to a first harness length and a prong coupled to a second harness length, wherein the seat belt webbing length adjusting buckle is capable of mating with the prong.
